(19) United States
(12) Patent Application Publication
(10) Pub. No.: US 2022/0102774 A1
(43) Pub. Date: Mar. 31, 2022

(54) METHOD FOR THE EXTRACTION OF LITHIUM FROM AN ELECTRIC BATTERY COMPRISING SOLID METALLIC LITHIUM

(71) Applicant: BLUE SOLUTIONS, Ergue Gaberic (FR)

(72) Inventors: Marc DESCHAMPS, Quimper (FR); Vincent BODENEZ, Saint Yvi (FR)

(21) Appl. No.: 17/426,513

(22) PCT Filed: Feb. 7, 2020
(86) PCT No.: PCT/EP2020/053209

§ 371 Date: Jul. 28, 2021

(30) Foreign Application Priority Data
Feb. 8, 2019 (FR) 1901268
Apr. 15, 2019 (FR) 1904014

(51) Int. Cl. H01M 10/54; C22B 7/00; C22B 26/12; C22B 1/00

(52) U.S. Cl. CPC H01M 10/54; C22B 7/003; H01M 10/0565; C22B 1/005; C22B 26/12

(57) ABSTRACT

A method for the extraction of lithium from an assembly of at least one cell of an electric battery including solid metallic lithium, such as a Lithium-Metal-Polymer battery, the method having an extraction phase including the following steps:
positioning the assembly in an orientation in which a first edge of the assembly from which extend(s) one or more negative electrode or electrodes is located below a second edge of the assembly, opposite the first edge, and from which extend(s) one or more positive electrode or electrodes; and
heating the assembly to a treatment temperature greater than or equal to the melting temperature of the solid metallic lithium.
An installation implementing such a method is also provided.

The present invention relates to a method for the extraction of lithium from a battery comprising solid metallic lithium.

The field of the invention is the field of batteries based on solid metallic lithium, and in particular Lithium-Metal-Polymer batteries, and even more particularly the field of the recycling of these batteries.

### STATE OF THE ART

Batteries based on solid metallic lithium are known, such as for example Lithium-Metal-Polymer (LMP®) batteries. These batteries are used increasingly, for example in electric vehicles or in electrical charging stations. Thus, the number of LMP® batteries has been increasing continuously for several years.

The lifetime of the LMP® batteries is not infinite and it appears necessary to recycle these batteries. Now, even at end-of-life, an LMP® battery still comprises solid metallic lithium, which can be reused in other batteries or in other fields, and the value of which is not insignificant.

However, there is currently no technique making it possible to satisfactorily recover the solid metallic lithium from a battery.

An aim of the present invention is to overcome this drawback.

Another aim of the invention is to propose a method for the recovery of the solid metallic lithium from an assembly of at least one electrical energy storage cell.

Another aim of the invention is to propose a method for the recovery of the solid metallic lithium from an assembly of at least one electrical energy storage cell, in a simple manner.

Another aim of the invention is to propose a method for the recovery of the solid metallic lithium from an assembly of at least one electrical energy storage cell, in an efficient manner while limiting and managing the effect of potential short-circuits during recycling.

### DISCLOSURE OF THE INVENTION

### First Solution Proposed by the Invention

According to a first solution, the invention makes it possible to achieve at least one of these aims by a method for the extraction of lithium from an assembly of at least one cell of an electric battery comprising solid metallic lithium, such as a Lithium-Metal-Polymer battery, said method comprising an extraction phase comprising the following steps:

positioning said assembly in an orientation in which a first edge of said assembly from which extend(s) one or more negative electrode or electrodes is located below a second edge of said assembly, opposite said first edge, and from which extend(s) one or more positive electrode or electrodes.

heating said assembly to a temperature, called treatment temperature, greater than or equal to the melting temperature of said solid metallic lithium.

The method according to the invention proposes to recover the lithium from a battery comprising solid lithium, by treating the cells composing said battery, individually or together.

In addition, the method according to the invention proposes to recover the metallic lithium, preferably solid, from an assembly of at least one cell the lithium of which is in the liquid state, by heating said assembly of cell(s) to a treatment temperature greater than the melting temperature of the solid metallic lithium. Once molten, the metallic lithium is drained naturally from each cell, wholly or partially, under the effect of the force of gravity.

Thus, the method according to the invention allows simple and not very complex recovery of the solid metallic lithium.

Moreover, the method according to the invention proposes a specific orientation for each cell, the latter having a minimum inclination, so that the first edge from which the negative electrode extends is located below the level of the second edge, opposite the first edge, from which the positive electrode extends. Such an orientation of each cell makes it possible on the one hand to facilitate the flow of the molten lithium out of the cell by gravity, and on the other hand to avoid a contact between the molten lithium and the positive electrode or the current collector of the positive electrode, such a contact being capable of causing an electrical short-circuit or an electric arc, such a short-circuit being capable of causing a fire.

In the present application, by “electrical energy storage cell” is meant an assembly comprising, at least:

a negative electrode formed by, or comprising, a layer of solid metallic lithium;

a positive electrode,

a solid electrolyte, in particular comprising lithium salt, arranged between the positive electrode and the negative electrode, and

a current collector on the side of the positive electrode.

In the present application, the “solid metallic lithium” can comprise:

pure metallic lithium; or

a combination of at least one metallic lithium alloy; or

a combination of pure metallic lithium and at least one metallic lithium alloy.

When the “solid metallic lithium” comprises a combination of different forms of lithium, such as those indicated above, having different melting temperatures, then the heating step carries out heating the assembly of cell(s) to a treatment temperature greater than or equal to:

the lowest of said different melting temperatures; and

preferentially, the highest of said different melting temperatures.

According to a non-limitative embodiment example, the treatment temperature is greater than or equal to 180.5° C.

According to an embodiment example, the treatment temperature is less than or equal to a maximum temperature, for example of 300° C.

The assembly can comprise one single or only cell.

The assembly can comprise several cells assembled, or in particular stacked, in an assembly direction. The assembly direction can be perpendicular to the plane formed by each cell.

In particular, the assembly can correspond to a battery in which the cells are connected in series.

According to a preferred embodiment, the positioning step can carry out a vertical positioning of the assembly of cell(s), in which the first edge is located downwards.

Thus, the gravitational flow of the molten lithium out of each cell is improved.

In addition, the risk of contact between the molten lithium and the positive electrode or electrodes is reduced, or zero.

Preferentially, the step of heating the assembly of cell(s) can be carried out under inert gas.

Thus, the method according to the invention reduces the risks of accidents, in particular, fire risks.

In addition, the method according to the invention makes it possible to avoid the formation of polluting compounds that may be generated by unwanted or uncontrolled physico-chemical reactions during the extraction of the lithium.

According to a non-limitative example, the inert gas can be, or comprise, any one of the following gases: helium (He), neon (Ne), argon (Ar), krypton (Kr), xenon (Xe) and radon (Rn).

According to another embodiment, the step of heating the assembly of cell(s) can be carried out under vacuum.

According to a particularly advantageous characteristic, the method according to the invention can also comprise, before the extraction phase, a step of electrical charging of the assembly of cell(s), said extraction phase being applied to said charged assembly.

The fact of electrically charging the cell or cells, and of carrying out the extraction phase on the electrically charged cells, makes it possible to increase the lithium extraction yield. In fact, the electrical charging of a cell makes it possible to displace the lithium ions towards the negative electrode, which allows the recoverable quantity of lithium to be increased.

Each cell can be charged individually, or by electrical charging of the assembly of cell(s).

According to a particularly advantageous embodiment, the extraction phase can also comprise a step of compressing the assembly of cell(s).

Thus, the molten lithium is forced to drain out of each cell, which increases the quantity of lithium recovered.

The compression step can be carried out continuously, throughout the extraction phase. In this case, each cell is subjected to a compression, partially or wholly, throughout the entire duration of the extraction phase.

Alternatively, the compression step can be carried out separately, once or several times, during the extraction phase. In this case, the extraction phase includes moments when the assembly of cell(s) is not subjected to a compression.

Advantageously, the compression step can apply a compression to the surface of the assembly of cell(s) by sweeping the surface of said assembly from the second edge to the first edge. Thus, the molten lithium is conveyed/guided progressively towards the first edge from which extend(s) one or more negative electrode or electrodes, which increases the quantity of lithium recovered and reduces the risk of contact between the lithium and the positive electrode or electrodes.

For example, the compression step can be carried out by passing the assembly of cell(s) between two rollers.

According to another example, the compression step can be carried out by a compression roller compressing the assembly of cell(s) against a bearing surface.

The compression can be applied by successive passes, each pass sweeping the surface of the assembly of cell(s), starting from the second edge to the first edge.

The gap between the compression rollers, respectively between the compression roller and the bearing surface, can correspond to the thickness of the assembly of cell(s) minus the thickness of the solid metallic lithium layer or layers. This makes it possible to apply a compression, while solid lithium still remains in the cell(s) assembly.

The gap between the two compression rollers, or respectively between the compression roller and the bearing surface, can be reduced with successive passes, so as to still apply a compression on the assembly of cell(s).

The speed of passage between the compression rollers, respectively of the compression roller, and more generally the sweeping speed, can be comprised between a few mm and a few tens of mm per second.

Moreover, the method according to the invention can comprise, before the extraction phase, a step of removing at least one electrical connector, also known as a “crimp connector”, from at least one cell.

This makes it possible to facilitate the treatment of the assembly of cell(s).

Moreover, the method according to the invention can comprise, before the extraction phase, a step of removing excess material at the level of at least one, and particularly each, edge of the assembly of cell(s).

According to another aspect of the same invention, an installation is proposed for the extraction of lithium from an assembly of at least one cell of an electric battery comprising solid metallic lithium, such as a Lithium-Metal-Polymer battery, said installation comprising:

a means for positioning said assembly in an orientation in which a first edge of said assembly from which extend(s) one or more negative electrode(s) is located below a second edge of said assembly, opposite said first edge, and from which extend(s) one or more positive electrode or electrodes; and

a heating means configured for heating said assembly to a treatment temperature greater than or equal to the melting temperature of said solid metallic lithium.

Generally, the installation comprises means configured to implement any combination of at least one of the characteristics described above, which for the sake of brevity are not described in detail herein.

In particular, the heating means can comprise an oven.

Advantageously, the oven can be filled with an inert gas, or be placed under vacuum.

The installation according to the invention can also comprise a means for compressing the assembly of cell(s).

The compression means can comprise at least one roller.

In particular, the compression means can comprise a single roller compressing the assembly of cell(s) against a bearing surface. The bearing surface can be heated to accelerate the temperature increase of the assembly of cell(s).

Alternatively, the compression means can comprise two rollers between which the assembly of cell(s) is passed.

Generally, the compression means can be configured to apply a continuous compression throughout the extraction phase.

Alternatively, the compression means can be configured to apply a compression discontinuously over time, once or several times, during the extraction phase. In this case, the extraction phase includes moments when the assembly of cell(s) is not subjected to a compression.

Advantageously, the compression step can be configured to apply a compression, with a constant or variable value, progressively or by sweeping over the surface of the assembly of cell(s), from the second edge to the first edge. Thus, the molten lithium is conveyed/guided progressively towards the first edge located in low position, which increases the quantity of lithium recovered and reduces the risk of contact between the lithium and the positive electrode or electrodes.

In the case of use of one or two compression rollers, then the compression can be applied to the assembly of cells by successive passes. Each pass applies a compression by sweeping over the surface of the assembly of cell(s), from the second edge to the first edge. At the end of each pass, the compression can be stopped, by withdrawing the rollers or by withdrawing the roller from the bearing surface, to return to the second edge in order to start a fresh pass.

The distance between the rollers, respectively between the compression roller and the bearing surface, can be reduced with successive passes, in particular between two successive passes.

The method according to the invention can be implemented to treat several assemblies of cell(s), in particular several assemblies of cells forming a battery pack and connected together in parallel within said battery pack.

At least two assemblies of cell(s) can be aligned side by side, without overlapping, for example in a direction parallel to the first edge.

In this case, the compression can be applied to at least two assemblies of cell(s) by one and the same compression means, namely a set of rollers, or one roller cooperating with a bearing surface.

### Second Solution Proposed by the Invention

According to a second solution, the invention makes it possible to achieve at least one of these aims by a method for the extraction of lithium from an assembly of at least one cell of an electric battery comprising solid metallic lithium, such as a Lithium-Metal-Polymer battery, said method comprising an extraction phase comprising the following steps:

positioning said assembly in an orientation in which a first edge of said assembly from which extend(s) one or more negative electrodes is located above a second edge of said assembly, opposite said first edge, and from which extend(s) one or more positive electrode or electrodes.

a step of immersion of the assembly of cell(s) in a liquid that is denser than the liquid lithium and electrically insulating; and

heating said assembly to a temperature, called treatment temperature, greater than or equal to the melting temperature of said solid metallic lithium.

The method according to the invention proposes to recover the lithium from a battery comprising lithium, by treating the cells composing said battery, individually or together.

In addition, the method according to the invention proposes to recover the metallic lithium from an assembly of at least one cell the lithium of which is brought to the liquid state, by heating said assembly of cell(s) to a treatment temperature greater than the melting temperature of the solid metallic lithium. Once molten, the metallic lithium drains naturally from each cell under the effect of the difference in density. Thus, the method according to the invention allows simple and not very complex recovery of the solid metallic lithium.

Moreover, the method according to the invention proposes a specific orientation for each cell, the latter having a minimum inclination, so that the first edge from which the negative electrode extends is located above the level of the second edge, opposite the first edge, from which the positive electrode extends. Such an orientation of each cell makes it possible on the one hand to facilitate the flow of the molten lithium out of the cell by difference in density, and on the other hand to avoid a contact between the molten lithium and the positive electrode or the current collector of the positive electrode, such a contact being capable of causing an electrical short-circuit, such a short-circuit being capable of causing a fire. In addition, immersion of the assembly of cell(s) in a liquid makes it possible to improve the dissipation of calories from the cell, in particular during a short-circuit, and thus to significantly limit the effect thereof.

In the present application, by “electrical energy storage cell” is meant an assembly comprising, at least:

a negative electrode formed by, or comprising, a layer of solid metallic lithium;

a positive electrode,

a solid electrolyte, in particular comprising lithium salt, arranged between the positive electrode and the negative electrode, and

a current collector on the side of the positive electrode.

In the present application, by “density” is meant the ratio between the mass density of the liquid in question and the mass density of water.

In the present application, “solid metallic lithium” can comprise:

pure metallic lithium; or

a combination of at least one metallic lithium alloy; or

a combination of pure metallic lithium and at least one metallic lithium alloy.

When the “solid metallic lithium” comprises a combination of different forms of lithium, such as those indicated above, having different melting temperatures, then the heating step carries out heating the assembly of cell(s) to a treatment temperature greater than or equal to:

the lowest of said different melting temperatures; or preferentially, the highest of said different melting temperatures, or

a combination of the different temperatures, for example, or through a temperature gradient that extends from the first edge to the second edge.

According to a non-limitative embodiment example, the treatment temperature, in the case of utilization of pure metallic lithium, is greater than or equal to 180.5° C.

According to an embodiment example, the treatment temperature is less than or equal to a maximum temperature, for example of 300° C.

The assembly can comprise one single or only cell.

The assembly can comprise several cells assembled, or in particular stacked, in an assembly direction. The assembly direction can be perpendicular to the plane formed by each cell.

In particular, the assembly can correspond to a battery in which the cells are connected in series.

According to a preferred embodiment, the positioning step can carry out a vertical positioning of the assembly of cell(s), in which the first edge is located upwards.

Thus, the flow of the molten lithium out of each cell, by difference in density, is improved.

In addition, the risk of contact between the molten lithium and the positive electrode or electrodes is reduced, or zero.

Preferentially, the immersion step is carried out by immersing the assembly of cell(s) completely in the liquid.

Thus, the method according to the invention reduces the risks of accidents, in particular, fire risks. In addition, the method according to the invention makes it possible to avoid the formation of polluting compounds that may be generated by unwanted or uncontrolled physico-chemical reactions during the extraction of the lithium, in particular by controlling the treatment temperature and the density of the liquid so that only the lithium or the lithium alloy can be extracted.

According to a particularly advantageous characteristic, the method according to the invention can also comprise, before the extraction phase, a step of electrical charging of the assembly of cell(s), said extraction phase being applied to said charged assembly.

The fact of electrically charging the cell or cells, and of carrying out the extraction phase on the electrically charged cells, makes it possible to increase the lithium extraction yield. In fact, the electrical charging of a cell makes it possible to displace the lithium ions towards the negative electrode, which allows the recoverable quantity of lithium to be increased.

Each cell can be charged individually, or by electrical charging of the assembly of cell(s).

According to a particularly advantageous embodiment, the extraction phase can also comprise a step of compressing the assembly of cell(s).

Thus, the molten lithium is forced to drain out of each cell, which increases the quantity of lithium recovered and the kinetics of the process.

The compression step can be carried out continuously, throughout the extraction phase. In this case, each cell is subjected to a compression, partially or wholly, throughout the entire duration of the extraction phase.

Alternatively, the compression step can be carried out separately, once or several times, during the extraction phase. In this case, the extraction phase includes moments in which the assembly of cell(s) is not subjected to a compression.

Advantageously, the compression step can apply a compression to the surface of the assembly of cell(s) by sweeping the surface of said assembly from the second edge to the first edge. Thus, the molten lithium is conveyed/guided progressively towards the first edge from which extend(s) one or more negative electrodes, which increases the quantity of lithium recovered and reduces the risk of contact between the lithium or lithium alloy and the positive electrode or electrodes.

For example, the compression step can be carried out by passing the assembly of cell(s) between two rollers.

According to another example, the compression step can be carried out by a compression roller compressing the assembly of cell(s) against a bearing surface.

The compression step can be applied by successive passes, each pass sweeping the surface of the assembly of cell(s), starting from the second edge to the first edge.

The gap between the compression rollers, respectively between the compression roller and the bearing surface, can correspond to the thickness of the assembly of cell(s) minus the thickness of the solid metallic lithium layer or layers. This makes it possible to apply a compression, while solid lithium still remains in the assembly of cell(s).

The gap between the two compression rollers, respectively between the compression roller and the bearing surface, also called platen, can be reduced with successive passes, so as to still apply a compression on the assembly of cell(s).

The speed of passage between the compression rollers, or respectively of the compression roller cooperating with a platen, and more generally the sweeping speed, can be comprised between a few mm and a few tens of mm per second.

Moreover, the method according to the invention can comprise, before the extraction phase, a step of removing at least one electrical connector, also known as a “crimp connector”, from the cell.

This makes it possible to facilitate the treatment of the assembly of cell(s).

Moreover, the method according to the invention can comprise, before the extraction phase, a step of removing excess material at the level of at least one, and particularly each, edge of the assembly of cell(s).

According to another aspect of the same invention, an installation is proposed for the extraction of lithium from an assembly of at least one electric battery cell comprising solid metallic lithium, such as a Lithium-Metal-Polymer battery, said installation comprising:

a means for positioning said assembly in an orientation in which a first edge of said assembly from which extend(s) one or more negative electrode or electrodes is located above a second edge of said assembly, opposite said first edge, and from which extend(s) one or more positive electrode or electrodes;

an oven filled with a liquid that is denser than the liquid lithium and electrically insulating; and

a heating means configured for heating said assembly to a treatment temperature greater than or equal to the melting temperature of said solid metallic lithium.

Generally, the installation comprises means configured to implement any combination of at least one of the characteristics described above, which for the sake of brevity are not described in detail herein.

The liquid can be a natural or synthetic oil, comprising the following physico-chemical properties:

hydrophobic and non-reactive with respect to the lithium,

electrically insulating,

having a density greater than that of the lithium,

thermally stable beyond the melting temperature of the lithium, i.e. 180.5° C.,

a flash point, as well as a self-ignition point, as high as possible.

The installation according to the invention can also comprise a means for compressing the assembly of cell(s).

The compression means can comprise at least one roller.

In particular, the compression means can comprise a single roller compressing the assembly of cell(s) against a bearing surface. The bearing surface can be heated to accelerate the temperature increase of the assembly of cell(s).

Alternatively, the compression means can comprise two rollers between which the assembly of cell(s) is passed.

Generally, the compression step can be configured to apply a continuous compression throughout the extraction phase.

Alternatively, the compression means can be configured to apply a compression discontinuously over time, once or several times, during the extraction phase. In this case, the extraction phase includes moments when the assembly of cell(s) is not subjected to a compression.

Advantageously, the compression means can be configured to apply a compression, with a constant or variable value, progressively or by sweeping over the surface of the assembly of cell(s), from the second edge to the first edge. Thus, the molten lithium is conveyed/guided progressively towards the first edge located in low position, which increases the quantity of lithium recovered and reduces the risk of contact between the lithium and the positive electrode or electrodes.

In the case of use of one or two compression rollers, then the compression can be applied on the assembly of cells by successive passes. Each pass applies a compression by sweeping over the surface of the assembly of cell(s), from the second edge to the first edge. At the end of each pass, the compression can be stopped, by withdrawing the rollers or by withdrawing the roller from the bearing surface, to return to the second edge in order to start a fresh pass.

The distance between the rollers, respectively between the compression roller and the bearing surface, can be reduced with successive passes, and in particular between two successive passes.

The method according to the invention can be implemented to treat several assemblies of cell(s), in particular several assemblies of cells forming a battery pack and connected together in parallel within said battery pack.

At least two assemblies of cell(s) can be aligned side by side, without overlapping, for example in a direction parallel to the first edge.

In this case, the compression can be applied to at least two assemblies of cell(s) by one and the same compression means, namely a set of rollers, or one roller cooperating with a bearing surface.

### DESCRIPTION OF THE FIGURES AND EMBODIMENTS

Other advantages and characteristics will become apparent on examination of the detailed description of embodiments which are in no way limitative, and from the attached drawings in which:

FIG. 1 is a diagrammatic representation of a non-limitative embodiment example of a cell within the meaning of the present invention;

FIG. 2 is a diagrammatic representation of a non-limitative embodiment example of an assembly of cells within the meaning of the present invention;

FIG. 3 is a diagrammatic representation of a first non-limitative embodiment example of a method according to the invention, conforming to the first solution proposed;

FIG. 4 is a diagrammatic representation of a second non-limitative embodiment example of a method according to the invention, conforming to the first solution proposed; and

FIG. 5 is a diagrammatic representation of a non-limitative embodiment example of an installation according to the invention, conforming to the first solution proposed;

FIG. 6 is a diagrammatic representation of a first non-limitative embodiment example of a method according to the invention, conforming to the second solution proposed;

FIG. 7 is a diagrammatic representation of a second non-limitative embodiment example of a method according to the invention, conforming to the second solution proposed;

FIG. 8 is a diagrammatic representation of a non-limitative embodiment example of an installation according to the invention, conforming to the second solution proposed.

It is well understood that the embodiments that will be described hereinafter are in no way limitative. Variants of the invention can be envisaged comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

In the present application, by “density” is meant the ratio between the mass density of the liquid in question and the mass density of water.

The liquid can be a natural or synthetic oil, comprising the following physico-chemical properties:

hydrophobic and non-reactive with respect to lithium,

electrically insulating,

having a density greater than that of lithium,

thermally stable beyond the melting temperature of lithium, i.e. 180.5° C.,

a flash point, as well as a self-ignition point, as high as possible.

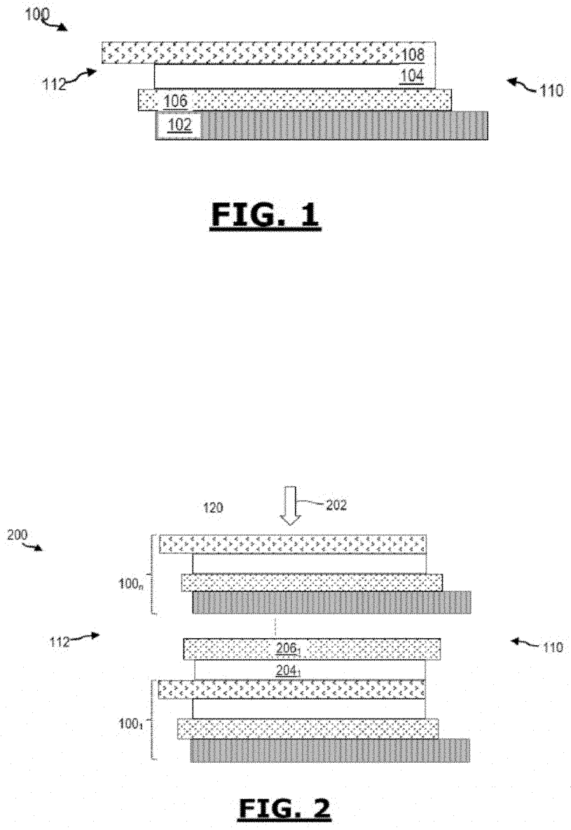

FIG. 1 is a diagrammatic representation of a non-limitative embodiment example of a cell within the meaning of the present invention, regardless of which of the two proposed solutions is implemented.

The cell 100, shown in FIG. 1, comprises a negative electrode 102 formed by, or comprising, a layer of solid metallic lithium.

The cell 100 also comprises a positive electrode 104. The positive electrode 104 is generally formed by a layer of composite based on polymer and active material.

A layer 106 of solid electrolyte is arranged between the negative electrode 102 and the positive electrode 104. This layer of solid electrolyte 106 can for example comprise lithium salt.

The cell 100 also comprises a current collector 108 on the side of the positive electrode 104. The current collector 108 is generally produced from aluminium.

Conventionally, the negative electrode 102 of the cell 100 extends beyond the other elements of the cell 100 on the side of a first edge 110 of the cell 100, here to the right of the figure; and the positive electrode 104 and/or the collector 108 of the cell 100 (said collector 108 is connected to the positive electrode 104) extend(s) beyond the other elements of the cell 100 on the side of a second edge 112, opposite the first edge 110. In the example shown, only the collector 108 extends beyond the assembly 100 on the second edge 112 thereof, here to the left of the figure. In other examples, the extension may involve only the positive electrode 104, or also the positive electrode 104 and the collector 108.

Of course, the cell 100 shown in FIG. 1 is a very simplified version of realization, given by way of non-limitative illustration. The cell within the meaning of the present invention can comprise layers other than those indicated, or more layers, or layers the composition of which is different from the composition given here by way of non-limitative example.

FIG. 2 is a diagrammatic representation of a non-limitative embodiment example of an assembly of cell(s) within the meaning of the present invention, regardless of which of the two proposed solutions is implemented.

The cell assembly 200, shown in FIG. 2, comprises one or more cells within the meaning of the present invention.

In particular, the cell assembly 200 comprises several identical cells 100₁-100ₙ, assembled in a direction 202 perpendicular to the plane of the layers of each cell 100ᵢ.

Each cell 100, may be identical to the cell 100 in FIG. 1.

In addition, between two adjacent cells 100ᵢ-100ᵢ₊₁, with i<n, are arranged a positive electrode 204ᵢ and a current collector 206ᵢ which is connected thereto.

### Embodiment Examples according to the First Solution Proposed

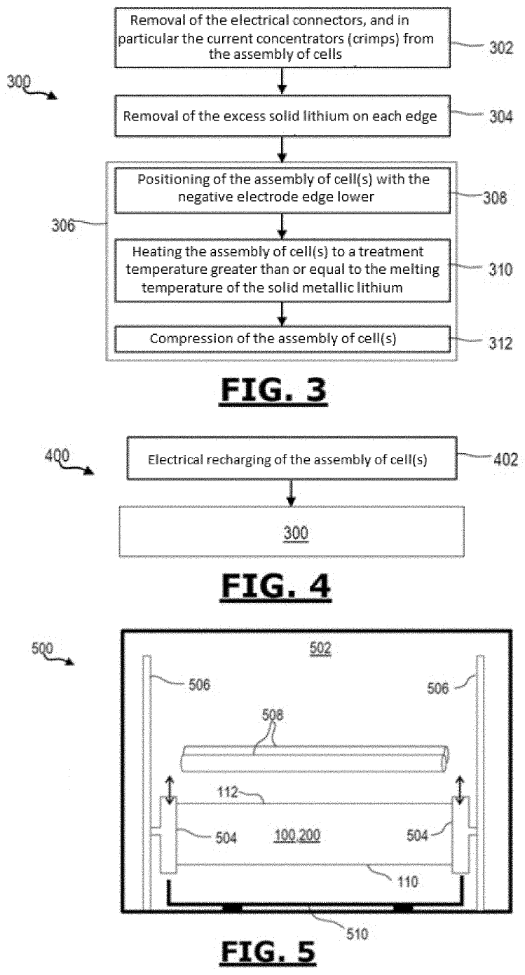

FIG. 3 is a diagrammatic representation of a first non-limitative embodiment example of a method according to the invention, conforming to the first solution proposed;

The method 300, shown in FIG. 3, comprises a first, optional, step 302 during which the electrical connectors, and in particular the current concentrators, also known as “crimp connectors”, of the assembly of cell(s) are removed.

During an optional step 304, excess material, in particular solid metallic lithium, at the level of each side edge of the assembly of cell(s) is removed.

Then, the method 300 comprises a phase 306 of extraction of the metallic lithium from the cells.

The extraction phase 306 comprises a step 308 of positioning the assembly of cell(s) in an orientation in which the first edge from which extend(s) the negative electrode or electrodes is located at a lower level than the second edge from which extend(s) the positive electrode or electrodes and the collectors. In particular, the step 308 positions the assembly of cell(s) in a vertical orientation, i.e. parallel to the gravity vector, with the edge from which extend(s) the negative electrode or electrodes, downwards. Preferentially, but in no way limitatively, the assembly of cell(s) is held in this orientation throughout the entire extraction phase 306.

The extraction phase 306 also comprises a step 310 of heating the assembly of cell(s) to a treatment temperature greater than or equal to the melting temperature of the solid metallic lithium present in the assembly of cell(s), for example a temperature of 180.5° C. This temperature will cause the melting of the solid metallic lithium and extraction thereof from each cell by natural drainage under the effect of gravity. Preferentially, but in no way limitatively, the assembly of cell(s) is maintained at this temperature throughout the entire extraction phase 306.

Advantageously, the heating step is carried out in a closed enclosure filled with inert gas.

The extraction phase 306 can also comprise an optional step 312 of compressing the assembly of cell(s) so as to flush the molten lithium out of each cell. The compression can be carried out continuously over all or part of the extraction phase 306. Alternatively, the compression step 312 can be reiterated discontinuously, several times during the extraction phase 306. Preferentially, the compression step 312 carries out an application of the compression, progressively or by sweeping over the surface of the assembly of cell(s), starting from the second edge from which extend(s) the positive electrode or electrodes and moving towards the first edge from which extend(s) the negative electrode or electrodes.

FIG. 4 is a diagrammatic representation of another non-limitative embodiment example of a method according to the invention, conforming to the first solution proposed.

The method 400, shown in FIG. 4, comprises all the steps of the method 300 in FIG. 3.

The method 400 also comprises, prior to the steps of the method 300, a step 402 carrying out an electrical recharging of the treated cell(s).

Each cell can be partially or totally recharged.

The fact of electrically charging each cell makes it possible to increase the quantity of lithium available for extraction, as the electrical recharging causes migration of the lithium ions to the negative electrode of the cell.

FIG. 5 is a diagrammatic representation of a non-limitative embodiment example of an installation according to the invention, conforming to the first solution proposed.

The installation 500, shown in FIG. 5, can be used to implement the method according to the invention, and in particular the methods 300 and 400 in FIGS. 3 and 4.

The installation 500 makes it possible to extract and recover a part or all of the lithium from a battery cell comprising solid metallic lithium, such as for example the cell 100 in FIG. 1, or from an assembly of cells such as the assembly 200 in FIG. 2.

The installation 500 comprises an oven 502, filled with an inert gas or placed under vacuum, configured to heat the cell to a treatment temperature greater than or equal to the melting temperature of the solid metallic lithium present in the cells, for example 180.5° C. or 181° C.

The installation 500 comprises a pair of jaws 504 for holding the cell 100, or the cell assembly 200, in a vertical, or at least inclined, position in which the first edge 110 is positioned below the level of the second edge 112. Each jaw 504 is mounted mobile on a vertical rail 506 so as to displace the cell, or the assembly of cells 200, vertically.

The installation 500 also comprises a pair of rollers 508, having between them a gap corresponding to the thickness of the cell 100, or of the assembly of cells 200, minus the thickness of the solid layer(s) of metallic lithium. The pair of rollers is positioned so that when the jaws 504 are displaced upwards, the cell 100, respectively the assembly of cell(s) 200, passes between the rollers 508, starting from the second edge 112. Thus, the rollers apply a compression to the cell 100, respectively to the cell assembly 200 progressively, starting from the second edge 112 and moving towards the first edge 110.

The installation also comprises a receptacle 510 for recovering the molten metallic lithium which flows out of each cell under the effect of gravity. The receptacle 510 must be inert with respect to lithium.

### Embodiment Examples according to the Second Solution Proposed

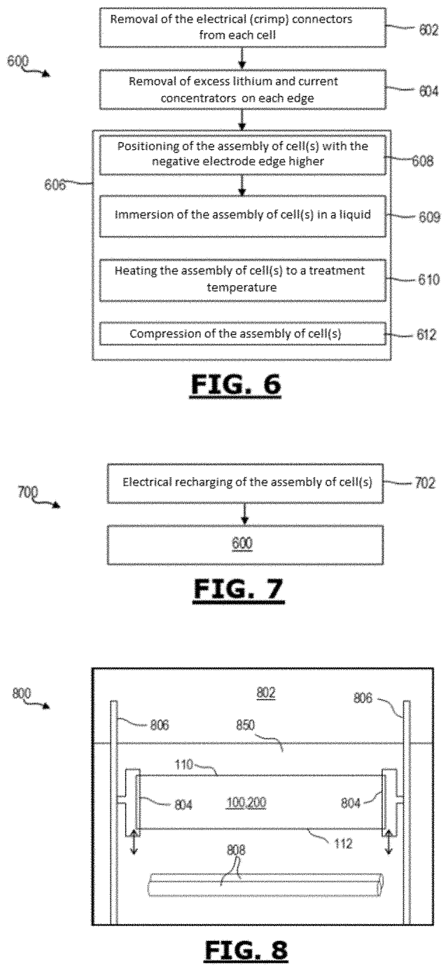

FIG. 6 is a diagrammatic representation of a non-limitative embodiment example of a method according to the invention, conforming to the second solution proposed;

The method 600, shown in FIG. 6, comprises a first, optional, step 602 during which the electrical connectors, also known as “crimp connectors”, of each battery cell are removed.

During an optional step 604, excess material at the level of each side edge of the assembly of cells is removed.

Then, the method 600 comprises a phase 606 of extraction of the metallic lithium from the cells.

The extraction phase 606 comprises a step 608 of positioning the assembly of cell(s) in an orientation in which the first edge 110 from which extend(s) the negative electrode or electrodes 102 is located at a higher level, in a vertical direction, than the second edge 112 from which extend(s) the positive electrode or electrodes 104 and the collectors. In particular, the step 608 positions the assembly of cell(s) in a vertical orientation, i.e. parallel to the gravity vector, with the edge from which extend(s) the negative electrode or electrodes 102, upwards. Preferentially, but in no way limitatively, the assembly of cell(s) is held in this orientation throughout the entire extraction phase 606.

The extraction phase 606 comprises a step 609 of immersion of the assembly of cell(s) in a liquid 850 (see FIG. 8). For example in the embodiment shown in FIG. 8, the liquid 850 is a natural or synthetic oil, for example a paraffin oil, comprising the following physico-chemical properties:

hydrophobic and non-reactive with respect to lithium,

electrically insulating,

having a density greater than that of lithium,

thermally stable beyond the melting temperature of lithium, i.e. 180.5° C., and

a flash point, as well as a self-ignition point, as high as possible, for example a temperature greater than 600° C., and as a minimum greater than the treatment temperature of the cell.

The immersion step 609 is carried out by immersing the assembly of cell(s) 200 in the liquid 850 so that the liquid 850 completely covers the assembly of cell(s) 200.

This immersion step 609 is particularly advantageous for promoting significant heat exchange between the cell and the liquid 850, which limits the risks of overheating of the cell and the evacuation of the calories generated during a short-circuit and improves the heating kinetics.

The extraction phase 606 also comprises a step 610 of heating the assembly of cell(s) to a treatment temperature greater than or equal to the melting temperature of the solid metallic lithium present in the assembly of cell(s), for example a temperature of 180.5° C. In the embodiment presented, the liquid 850 is heated by the oven, and transfers heat to the assembly of cell(s). Once greater than the melting temperature of lithium, the temperature causes the melting of the solid metallic lithium and extraction thereof from each cell by natural drainage under the effect of gravity. Preferentially, but in no way limitatively, the assembly of cell(s) is maintained at this temperature throughout the entire extraction phase 606. The treatment temperature must not exceed a degradation temperature of the liquid 850, specific to each liquid 850, beyond which the liquid 850 degrades. In other words, the liquid 850, when exceeding a threshold temperature, would change properties so that the aforementioned properties are no longer met. Ideally, the degradation temperature of the liquid must be greater than +40° C. (and for example between +60° C. and +60° C.) with respect to the melting temperature of lithium.

Thus the method for the extraction of lithium from a battery makes it possible to limit the effects of short-circuit electrical potentials by making the lithium flow via the first edge 110 from which extend(s) the negative electrode or electrodes 102, and to control short-circuits by immersing the assembly of cell(s) in a liquid that does not react with lithium and improving the dissipation of calories from the assembly of cell(s), in particular during a short-circuit.

The extraction phase 606 can also comprise an optional step 612 of compressing the assembly of cell(s) so as to accelerate the extraction of the molten lithium out of each cell. The compression can be carried out continuously over all or part of the extraction phase 606. Alternatively, the compression step 612 can be reiterated discontinuously, several times during the extraction phase 606. Preferentially, the compression step 612 carries out an application of the compression, progressively or by sweeping over the surface of the assembly of cell(s), starting from the second edge 112 from which extend(s) the positive electrode or electrodes 104 and moving towards the first edge 110 from which extend(s) the negative electrode or electrodes 102.

FIG. 7 is a diagrammatic representation of another non-limitative embodiment example of a method according to the invention, conforming to the second solution proposed;

The method 700, shown in FIG. 7, comprises all the steps of the method 600 in FIG. 6.

The method 700 also comprises, prior to the steps of the method 600, a step 702 carrying out an electrical recharging of the treated cell or cells.

Each cell can be partially or totally recharged.

The fact of electrically charging each cell makes it possible to increase the quantity of lithium available for extraction, as the electrical recharging causes migration of the lithium ions to the negative electrode of the cell, which improves the quantity of lithium extracted as well as the kinetics of the operation.

FIG. 8 is a diagrammatic representation of a non-limitative embodiment example of an installation according to the invention, conforming to the second solution proposed.

The installation 800, shown in FIG. 8, can be used to implement the method according to the invention, and in particular the methods 600 and 700 in FIGS. 6 and 7.

The installation 800 makes it possible to extract and recover a part or all of the lithium from a battery cell comprising solid metallic lithium, such as for example the cell 100 in FIG. 1, or from an assembly of cells such as the assembly 200 in FIG. 2.

The installation 800 comprises an oven 802, filled with a liquid 850, configured to heat the cell to a treatment temperature greater than or equal to the melting temperature of the solid metallic lithium present in the cells, for example 180.5° C. or 181° C. In the embodiment presented, the liquid 850 is heated by the oven 802, and transfers heat to the assembly of cell(s).

The installation 800 comprises a pair of jaws 804 for holding the cell 100, or the cell assembly 200, in a vertical, or at least inclined, position in which the first edge 110 is positioned above the level of the second edge 112. Each jaw 804 is mounted mobile on a vertical rail 806 so as to displace the cell 100, or the assembly of cells 200, vertically.

The liquid 850 completely covers the assembly of cell(s), so that the first edge 110 is situated below the level of the liquid 850.

The installation 800 also comprises a pair of rollers 808, having between them a gap corresponding to the thickness of the cell 100, or of the assembly of cells 200, minus the thickness of the solid layer or layers of metallic lithium. The pair of rollers is positioned so that when the jaws 804 are displaced upwards, the cell 100, respectively the assembly of cell(s) 200, passes between the rollers 808, starting from the second edge 112. Thus, the rollers apply a compression to the cell 100, respectively to the cell assembly 200 progressively, starting from the second edge 112 and moving towards the first edge 110.

Of course, the invention is not limited to the examples detailed above.

For example, the composition of the electric battery cell comprising solid metallic lithium can be different to that indicated in FIG. 1.

In addition, the installation according to the invention can comprise devices other than those shown in FIGS. 5 and 7, such as for example means for cutting off the electrical connectors from the cell, means for cutting off excesses on one, or each, of the edges.

For example, the jaws, respectively 504 and 804, can be fixed, and it is the rollers, respectively 508 and 808, that can be mobile and can compress the assembly of cell(s) from the top down, respectively from the bottom up, according to the embodiment.

In addition, it is possible to use a single oven and several pairs of rollers dedicated to one cell or an assembly of cells.

A pair of rollers can operate in order to simultaneously treat several adjacent assemblies of cell(s).

By way of example, the step 609 can be carried out by submerging the cell 100 or the assembly of cell(s) 200 in the liquid 850, or by filling the oven 802 with the liquid 850, so that the liquid 850 covers the assembly of cell(s) 200, respectively the cell 100.

It should be noted that the orientation of the first edge 110 of the assembly, from which extend(s) one or more negative electrode or electrodes 102, is a function of the density of the fluid in which the cell 100, or the assembly 200 of cells, is immersed. In the event that the fluid is a gas, which is covered by the first solution proposed by the present invention, then the first edge 110 will be situated below the second edge 112 from which extend(s) one or more positive electrode or electrodes 104, since the gas has a lower density than the lithium. In the event that the fluid is a liquid denser than the lithium, which is covered by the second solution proposed by the present invention, then the first edge 110 will be situated above the second edge 112.

In the event that the fluid is a liquid less dense than the lithium, then the orientation of the first edge 110 will be below the second edge 112, as shown in the first embodiment.

In addition, the direction of compression of the cell 100, by the rollers 508, respectively 808, is more advantageous for compressing the cell from the second edge 112 to the first edge 110. Thus according to the density of the fluid, the direction of compression is not identical, as can be seen in the examples shown in FIGS. 5 and 8.

The first edge 110 can be characterized by the fact that it defines the side via which the lithium must flow, once it is in the liquid state.

1. A method for the extraction of lithium from an assembly of at least one cell of an electric battery including solid metallic lithium, such as a Lithium-Metal-Polymer battery, said method having an extraction phase comprising the following steps:
positioning said assembly in an orientation in which a first edge of said assembly from which extend(s) one or more negative electrode or electrodes is located below a second edge of said assembly, opposite said first edge, and from which extend(s) one or more positive electrode(s); and
heating said assembly to a temperature, called treatment temperature, greater than or equal to the melting temperature of said solid metallic lithium.

2. The method according to claim 1, characterized in that the positioning step carries out a vertical positioning of the assembly of cell(s), in which the first edge is located downwards.

3. The method according to claim 1, characterized in that the step of heating the assembly of cell(s) is carried out under inert gas.

4. The method according to claim 1, characterized in that the step of heating the assembly of cell(s) is carried out under vacuum.

5. The method according to claim 1, characterized in that it also comprises, before the extraction phase, a step of electrical charging of the assembly of cell(s), said extraction phase being applied to said charged assembly.

6. The method according to claim 1, characterized in that the extraction phase also comprises a step of compression of the assembly of cell(s).

7. The method according to claim 6, characterized in that the compression step applies a compression to the surface of the assembly by sweeping the surface of the assembly from the second edge to the first edge.

8. The method according to claim 1, characterized in that it comprises, before the extraction phase, a step of removal of at least one electrical connector from at least one cell.

9. An installation for the extraction of lithium from an assembly of at least one cell of an electric battery including solid metallic lithium, such as a Lithium-Metal-Polymer battery, said installation comprising:
a means for positioning said assembly in an orientation in which a first edge of said assembly from which extend(s) one or more negative electrode or electrodes is located below a second edge of said assembly, opposite said first edge, and from which extend(s) one or more positive electrode or electrodes; and
heating means configured to heat said assembly to a treatment temperature greater than or equal to the melting temperature of said solid metallic lithium.

10. The installation according to claim 9, characterized in that the heating means comprises an oven filled with inert gas.

11. The installation according claim 9, characterized in that it comprises a compression means of the assembly of cell(s).

12. The installation according to claim 11, characterized in that the compression means comprises two rollers between which the assembly of cell(s) is passed.
